(19) United States
(12) Patent Application Publication
(10) Pub. No.: US 2006/0141316 A1
(43) Pub. Date: Jun. 29, 2006

(54) Proton conductor and electrochemical device using the same

(75) Inventor: Hyo-rang Kang, Anyang-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI Co., Ltd.

(21) Appl. No.: 11/274,210

(22) Filed: Nov. 16, 2005

(30) Foreign Application Priority Data
Dec. 23, 2004 (KR) 10-2004-0111168

(51) Int. Cl. H01M 8/10; C08J 5/22; H01M 4/88

(52) U.S. Cl. 429/33; 521/27; 502/101

(57) ABSTRACT

A proton conductor includes P₂O₅ and at least one of B₂O₃, ZrO₂, SiO₂, WO₃, and MoO₃. The proton conductor has an amorphous phase of 60 wt % or more. The proton conductor exhibits proton conductivity at temperatures above 100° C. without humidification.

### CROSS-REFERENCE TO RELATED PATENT APPLICATION

This application claims priority to and the benefit of Korean Patent Application No. 10-2004-0111168, filed on Dec. 23, 2004, which is hereby incorporated by reference for all purposes as if fully set forth herein.

### BACKGROUND OF THE INVENTION

1. Field of the Invention

The present invention relates to a proton conductor that may exhibit excellent proton conductivity at temperatures above 100° C. without humidification.

2. Discussion of the Background

Fuel cells are electrochemical devices that produce electrical energy through the electrochemical reaction of fuel and oxygen. Unlike thermal power generators, fuel cells are not subjected to the thermodynamic limitations of the Carnot cycle. Therefore, their theoretical power efficiencies are very high.

Currently known fuel cells can be classified into proton exchange membrane fuel cells (PEMFCs), phosphoric acid fuel cells (PAFCs), molten carbonate fuel cells (MCFCs), and solid oxide fuel cells (SOFCs) according to the type of electrolyte used in the cells. The operation temperature of the fuel cell and the materials used in the fuel cell vary according to the type of electrolyte.

Electrolyte membranes serve as separators to prevent physical contact between anodes and cathodes, and serve as ion conductors by transporting hydrogen ions (protons) from anodes to cathodes. Proton conductors distributed in the electrolyte membranes serve as the ion conductors. Proton conductors can be used in both electrolyte membranes and electrodes.

Proton conductors may be made of a perfluorosulfonated polymer called NAFION. Proton conductors made of NAFION have excellent mechanical strength, chemical stability, and ionic conductivity, but at temperatures above 80° C. they lose water, which hinders their ability to efficiently operate at such temperatures.

Non-humidified polymer electrolytes have been developed in an attempt to produce a proton conductor that can operate at high temperatures. One such non-humidified polymer electrolyte is a polybenzimidazole (PBI)-phosphoric acid (H₃PO₄) system that uses phosphoric acid as a proton conductor. One drawback of this system is that the phosphoric acid used in the PBI-phosphoric acid system is a liquid and may not be uniformly distributed on the surface of the carbon catalyst particles that form the electrodes. Instead, the phosphoric acid may be locally soaked in spaces between the carbon catalyst particles, which causes non-uniformity problems.

A redox reaction occurs at the surface of the catalyst on the electrodes. The redox reaction occurs most actively at a catalyst near an interface between a vapor phase and a liquid phase where material transport from the vapor phase to the liquid phase occurs smoothly. However, because the catalyst in the polybenzimidazole-phosphoric acid system is surrounded by liquid phosphoric acid, it is not supplied with material from the vapor phase and so participates very little in the redox reaction. This reduces the overall catalyst efficiency.

Another problem with the polybenzimidazole-phosphoric acid system is that phosphoric acid present in the electrolyte membrane or the electrode may leak and corrode the carbon bipolar plate. In this case, the corrosion occurs due to the formation of foreign substances produced by a reaction between the leaked phosphoric acid and a functional group on the carbon surface. The functional groups may be removed from a carbon bipolar plate by a high-temperature treatment at 2,800° C., which will prevent corrosion, but substantially increases the manufacturing cost of the fuel cell.

Metal phosphates such as tin phosphate (SnP₂O₇) and zirconium phosphate (ZrP₂O₇) have also been considered for use as a proton conductor. However, the preparation of the metal phosphate requires a temperature treatment above 500° C. and may not be performed in-situ with a platinum-carbon supported catalyst because the catalyst becomes too fragile at temperatures above 400° C.

Proton conductors manufactured according to conventional techniques are shown in FIG. 2A, FIG. 2B, and FIG. 3. FIG. 2A and FIG. 2B show proton conductors made of tin phosphate (SnP₂O₇) surrounded by phosphoric acid. Referring to FIG. 2A and FIG. 2B, many proton conductor particles are agglomerated by the phosphoric acid. FIG. 3 shows proton conductors made using 85% phosphoric acid (H₃PO₄) and boric acid. Referring to FIG. 3, BPO₄ particles are surrounded by the phosphoric acid and are considerably agglomerated. The tendency of these conventional proton conductors to be easily agglomerated causes them to be non-uniformly dispersed in a catalyst layer and to be converted from a solid state to a fluid state over time due to their moisture absorptivity. This may cause the gradual blocking of pores, which are needed as channels for material transport.

### SUMMARY OF THE INVENTION

The present invention provides a proton conductor that has sustained ionic conductivity at temperatures above 100° C. and under non-humidified conditions.

Additional features of the invention will be set forth in the description which follows, and in part will be apparent from the description, or may be learned by practice of the invention.

The present invention discloses a proton conductor that includes P2O5 and at least one material selected from B2O3, ZrO2, SiO2, WO3, and MoO3.

The present invention also discloses a polymer electrolyte membrane that includes a polymer matrix and a proton conductor that includes P2O5 and at least one material selected from B2O3, ZrO2, SiO2, WO3, and MoO3.

The present invention also discloses a fuel cell electrode that includes a supported catalyst and a proton conductor that includes P2O5 and at least one material selected from B2O3, ZrO2, SiO2, WO3, and MoO3.

The present invention also discloses a fuel cell that includes a cathode, an anode, an electrolyte membrane interposed between the cathode and the anode, where at least one of the cathode, the anode, and the electrolyte membrane includes a proton conductor that includes P2O5 and at least one material selected from B2O3, ZrO2, SiO2, WO3, and MoO3.

The present invention also discloses a method of manufacturing a proton conductor that includes mixing a solvent with boric acid (H₃BO3) and metaphosphoric acid to form a mixture and thermally treating the mixture.

The present invention also discloses a method of manufacturing a polymer electrolyte membrane that includes mixing a solvent with a polymer matrix, a metaphosphoric acid, and a boric acid to form a mixture and thermally treating the mixture.

The present invention also discloses a method of manufacturing a fuel cell electrode that includes mixing a solvent with a supported catalyst, a metaphosphoric acid, and a boric acid to form a mixture and thermally treating the mixture.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A and FIG. 1B are scanning electron microscopic (SEM) images of proton conductors according to an exemplary embodiment of the present invention manufactured by thermal treatment at 120° C. and 150° C., respectively.

FIG. 2A and FIG. 2B are SEM images of conventional proton conductors made of tin phosphate (SnP₂O₇).

FIG. 3 is a SEM image of a conventional proton conductor made using 85% phosphoric acid and boric acid.

FIG. 4 is an image of X-ray diffraction (XRD) graphs of the proton conductors of FIG. 1A, FIG. 1B, and FIG. 3.

FIG. 5 is a thermal gravimetric analysis (TGA) graph of a proton conductor manufactured according to Example 1 of the present invention.

FIG. 6 is a TGA graph of a proton conductor manufactured according to Example 2 of the present invention.

FIG. 7 is a TGA graph of a proton conductor manufactured according to the Comparative Example.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

A proton conductor according to an exemplary embodiment of the present invention includes P₂O₅ and at least one material selected from the group of B₂O₃, ZrO₂, SiO₂, WO₃, and MoO₃. The proton conductor has an amorphous phase of about 60 wt % or more.

In one exemplary embodiment of the present invention, metaphosphoric acid (HPO₃) and boric acid (H₃BO₃) are mixed and thermally treated to manufacture the proton conductor. Amorphous P₂O₅ and B₂O₃ are produced according to Reaction Scheme 1 and Reaction Scheme 2 below:
2HPO₃→P₂O₅+H₂O Reaction Scheme 1
2H₃BO₃→B₂O₃+3H₂O Reaction Scheme 2

About 60% or more of P₂O₅ and B₂O₃ produced during these reactions are in an amorphous phase.

Metaphosphoric acid and boric acid are mixed in a weight ratio in the range of about 1:0.2 to about 1:0.6 to manufacture the proton conductor.

In another exemplary embodiment of the present invention, orthophosphoric acid is used instead of metaphosphoric acid and the chemical reactions represented by Reaction Scheme 3 and Reaction Scheme 4 below occur:
H₃PO₄+H₃BO₃→BPO₄+3H₂O Reaction Scheme 3
2H₃PO₄→P₂O₅+3H₂O Reaction Scheme 4

Thermal treatment of orthophosphoric acid and boric acid produces crystalline BPO₄ through the active reaction of excess orthophosphoric acid and boric acid as represented by Reaction Scheme 3. Residual orthophosphoric acid produces P₂O₅ as shown by Reaction is Scheme 4. The weight ratio of metaphosphoric acid to boric acid is in the range from about 1:0.2 to about 1:0.6. If orthophosphoric acid is used instead of metaphosphoric acid in the process, the amorphous phase theoretically cannot exceed 60%.

In the proton conductor of the present invention, the weight ratio of P₂O₅ to B₂O₃ may be in the range from about 1:0.12 to about 1:0.40, the weight ratio of P₂O₅ to ZrO₂ may be in the range from about 1:0.21 to about 1:0.71, the weight ratio of P₂O₅ to SiO₂ may be in the range from about 1:0.10 to about 1:0.35, the weight ratio of P₂O₅ to WO₃ may be in the range from about 1:0.40 to about 1:1.33, and the weight ratio of P₂O₅ to MoO₃ may be in the range from about 1:0.25 to about 1:0.83. If the ratio of B₂O₃, ZrO₂, SiO₂, WO₃, or MoO₃ is excessively high, the ionic conductivity of the proton conductor may be lowered. On the other hand, if the ratio of P₂O₅ is excessively high, solidification of the proton conductor may be poor, thereby lowering formability and causing fluidization.

The proton conductor's ionic conductivity is affected by its crystallinity. As crystallinitydecreases, the ratio of the amorphous phase increases and the ionic conductivity increases.

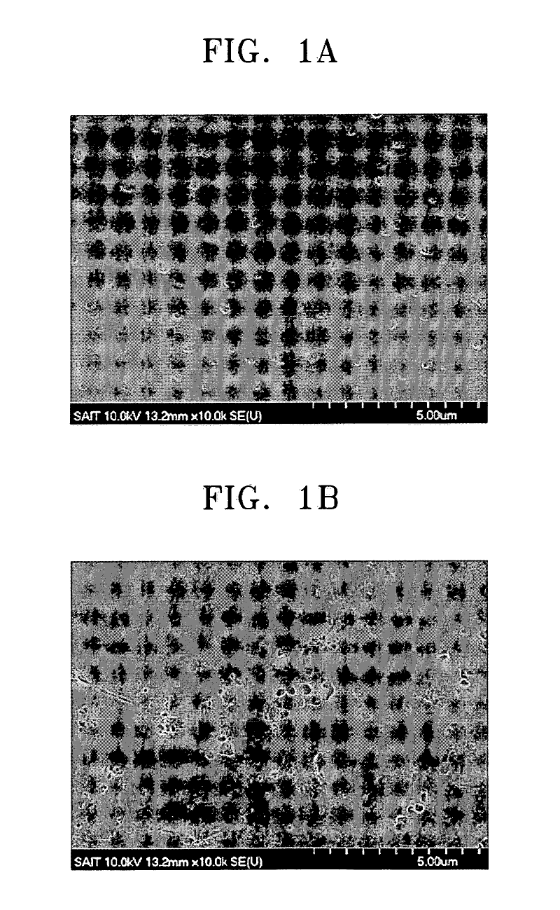

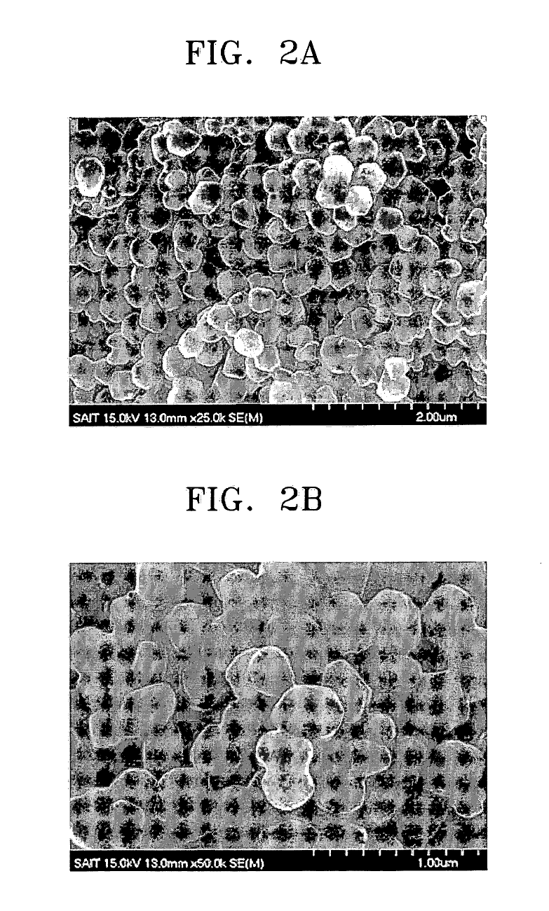

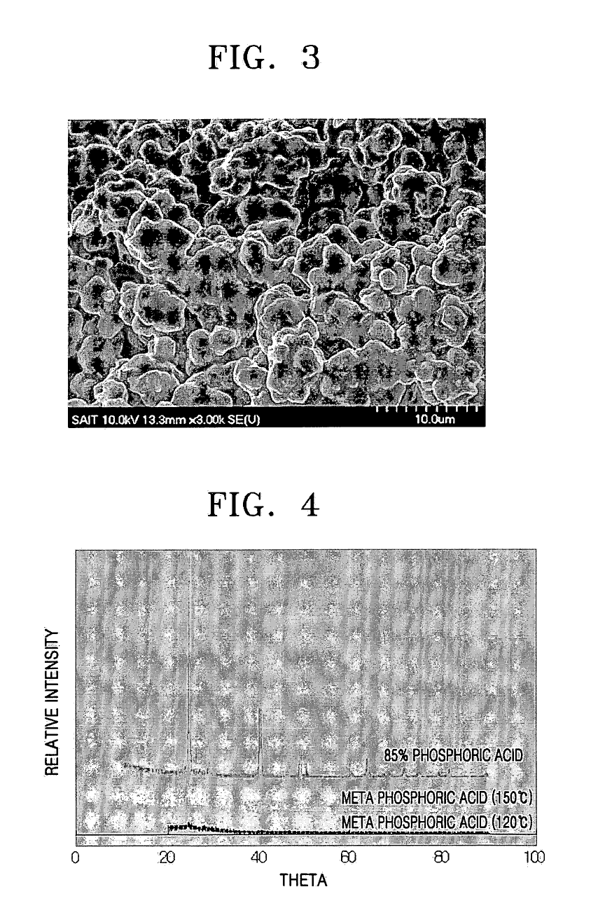

Scanning electron microscopic (SEM) images of proton conductors manufactured according to exemplary embodiments of the present invention are shown in FIG. 1A and FIG. 1B. FIG. 1A shows a proton conductor manufactured by thermal treatment at 120° C. FIG. 1B shows a proton conductor manufactured by thermal treatment at 150° C.

The proton conductor is mainly composed of an amorphous phase as shown in the SEM images of FIG. 1A and FIG. 1B. The proton conductor is in a solid phase and thus can be uniformly dispersed on the surface of a catalyst.

A method of manufacturing a proton conductor according to an exemplary embodiment of the present invention will now be described.

First, a solid acid of boron, zirconium, silicon, tungsten, or molybdenum and a metaphosphoric acid are mixed in a solvent. A boric acid, H₃BO₃, may be used as the solid acid of boron. The solvent may be a mono-component or multi-component dispersing agent capable of dissolving both the solid acid and the metaphosphoric acid. Examples of the solvent include water, methanol, ethanol, isopropyl alcohol (IPA), tetrabutylacetate, and n-butylacetate. These solvents may be used alone or in combination. Water, ethanol, and IPA may be used. If too little solvent is used, mixing the solid acid and the metaphosphoric acid may be difficult. On the other hand, if too much solvent is used, the time required for thermal treatment may need to be increased.

The metaphosphoric acid is a material with a chemical formula of (HPO₃)ₓ, where x is about 6. The metaphosphoric acid should be easily dissolvable in water and alcohol. The metaphosphoric acid may gradually convert to H₃PO₄ when it dissolves in water.

If too much metaphosphoric acid is used, solidification of the ion conductor may be poor. On the other hand, if too much solid acid is used, the ionic conductivity may decrease. Therefore, the weight ratio of the metaphosphoric acid to the solid acid may be in the range from about 1:0.01 to about 1:1, and preferably from about 1:0.2 to about 1:0.6.

The resultant mixture is thermally treated in a heating apparatus, such as an oven or a furnace. The thermal treatment temperature may be in the range from about 100° C. to about 400° C., and preferably from about 120° C. to about 200° C. If the thermal treatment temperature exceeds 400° C., the ionic conductivity of the proton conductor may decrease. On the other hand, if the thermal treatment temperature is less than 100° C., the duration of the thermal treatment may need to be increased. The duration of the thermal treatment may be selected according to the amount of the mixed components used to allow sufficient time to enable production of an amorphous product from the reactants and to allow the solvent to evaporate. The thermal treatment duration may be in the range from about 2 to about 36 hours.

The proton conductor is then cooled to room temperature, pulverized, and formed into an appropriate shape.

The proton conductor produced by the thermal treatment may be used in an electrochemical device such a fuel cell by including it in an electrode or a polymer electrolyte membrane. However, combining a separately manufactured proton conductor into an electrode or a polymer electrolyte membrane increases the manufacturing cost due to the additional process. Therefore, it is more cost effective to simultaneously manufacture a proton conductor and an electrode or a polymer electrolyte membrane.

A polymer electrolyte membrane that includes the proton conductor can be manufactured by the following method.

A polymer matrix, a solid acid, and a metaphosphoric acid are added to a solvent and mixed to obtain a uniform solution. The solvent is may be a mono-component or multi-component dispersing agent capable of dissolving both the solid acid and the metaphosphoric acid. Examples of the solvent include water, methanol, ethanol, IPA, tetrabutylacetate, and n-butylacetate. These solvents can be used alone or in combination. Water, ethanol, and IPA may be used. If too little solvent is used, the mixing of the solid acid and the metaphosphoric acid may be poor. On the other hand, if too much solvent is used, the time required for thermal treatment may need to be increased.

The polymer matrix may be selected from various heat resistant polymer matrices used for manufacturing a polymer electrolyte membrane. A polymer that can tolerate the thermal treatment at about 100° C. to about 400° C. and is stable at an operating temperature of about 150° C. or less when employed in a fuel cell may be used.

The polymer matrix may be a film made of at least one selected from a perfluorinated polymer such as NAFION, a hydrocarbon polymer, polyimide such as aromatic polyimide, polyvinylidenefluoride, polybenzimidazole (PBI), polysulfone, polyethersulfone, polyetherketone, polyphenylenesulfide, polyphenyleneoxide, polyphosphazine, polyethylenenaphthalate, polyester, polyamide such as aromatic polyamide, and a mixture thereof.

The weight ratio of the metaphosphoric acid to the solid acid may be in the range from about 1:0.01 to about 1:1, and preferably about 1:0.2 to about 1:0.6.

The mixture composed of the metaphosphoric acid and the solid acid may be used in an amount of about 50 to about 80 parts by weight, based on the total weight (100 parts by weight) of the mixture and the polymer matrix.

The resultant mixture is thermally treated in a heating apparatus, such as an oven or a furnace. The thermal treatment temperature may be in the range from about 100° C. to about 400° C., and preferably from about 120° C. to about 200° C. If the thermal treatment temperature exceeds about 400° C., the ionic conductivity of the proton conductor may be lowered. On the other hand, if the thermal treatment temperature is less than about 100° C., the duration of the thermal treatment may need to be increased. The duration of the thermal treatment may be selected according to the amount of the mixed components used to allow a sufficient time to enable production of an amorphous product from the reactants and to allow the solvent to evaporate. The duration of the thermal treatment may be in the range from about 2 to about 36 hours.

An electrode that includes the proton conductor can be manufactured by the following method.

A supported catalyst containing metal catalyst particles, a solid acid, and a metaphosphoric acid are added to a solvent and mixed. The solvent may be a mono-component or multi-component dispersing agent capable of dissolving the solid acid and the metaphosphoric acid. Examples of the solvent include water, methanol, ethanol, IPA, tetrabutylacetate, and n-butylacetate. These solvents can be used alone or in combination. Water, ethanol, and IPA may be used. If too little solvent is used, the mixing of the solid acid and the metaphosphoric acid may be poor. On the other hand, if too much solvent is used, the time required for thermal treatment may need to be increased.

The weight ratio of the metaphosphoric acid to the solid acid may be in the range from about 1:0.01 to about 1:1, preferably from about 1:0.2 to about 1:0.6.

The content of the mixture of the solid acid and the metaphosphoric acid may be in the range from about 5% to about 25% by weight of the supported catalyst. If the content of the mixture of the solid acid and the metaphosphoric acid is less than 5% by weight of the supported catalyst, the production amount of the proton conductor may be relatively lowered, which makes it difficult to achieve the desired ionic conductivity. On the other hand, if the content of the mixture of the solid acid and the metaphosphoric acid exceeds 25% by weight of the supported catalyst, the electrical contact between the supporting materials may be lowered, which decreases electrode efficiency.

Examples of the metal catalyst particles include platinum (Pt), ruthenium (Ru), tin (Sn), palladium (Pd), titanium (Ti), vanadium (V), chromium (Cr), manganese (Mn), iron (Fe), cobalt (Co), nickel (Ni), copper (Cu), zinc (Zn), aluminum (Al), molybdenum (Mo), selenium (Se), tungsten (W), iridium (Ir), osmium (Os), rhodium (Rh), niobium (Nb), tantalum (Ta), lead (Pb), and a combination thereof. Platinum or platinum alloy with nano-sized particles may be used.

The resultant mixture is thermally treated in a heating apparatus, such as an oven or a furnace. The thermal treatment temperature may be in the range from about 100° C. to about 350° C., preferably from about 120° C. to about 200° C. If the thermal treatment temperature exceeds about 350° C., the catalyst particles may be burnt. Thermal treatment above about 400° C. may lower the ionic conductivity of a proton conductor. On the other hand, if the thermal treatment temperature is less than 100° C., the duration of the thermal treatment may need to be increased. The duration of the thermal treatment may be selected according to the amount of the mixed components used to allow a sufficient time to enable production of an amorphous product from the reactants and to allow the solvent to evaporate. The duration of the thermal treatment may be in the range from about 2 to about 36 hours.

The manufactured electrode material is pulverized and mixed with a solvent to make a slurry. The solvent may be an organic solvent that is not capable of dissolving a finished proton conductor. Examples of the solvent include acetone, tetrahydrofuran (THF), dimethylsulfoxide (DMSO), N-methyl-2-pyrrolidone (NMP), N,N-dimethylacetamide (DMAc), dimethylformamide (DMF), m-cresol, toluene, ethyleneglycol (EG), γ-butyrolactone, and hexafluoroisopropanol (HFIP). These solvents may be used alone or in combination.

The slurry is coated on a gas diffusion layer. The gas diffusion layer may be carbon paper, water-proofed carbon paper, or water-proofed carbon paper or carbon cloth coated with a water-proofed carbon black layer.

The water-proofed carbon paper may include about 5 wt % to about 50 wt % of a hydrophobic polymer such as polytetrafluoroethylene (PTFE). The hydrophobic polymer may be sintered. The water-proofing treatment of the gas diffusion layer creates channels for polar liquid reactants and gaseous reactants.

The water-proofed carbon black layer of the water-proofed carbon paper includes a carbon black and a hydrophobic polymer such as PTFE as a hydrophobic binde, in an amount of about 20 wt % to about 50 wt %. The water-proofed carbon black layer is attached to a surface of the water-proofed carbon paper. The hydrophobic polymer of the water-proofed carbon black layer may be sintered.

The slurry may be coated on the gas diffusion layer by a screen printing method, a doctor blade method, a painting method, a spraying method, or the like. The coated slurry is dried at a temperature of about 60° C. to about 100° C.

The proton conductor may also be used in a cathode and an anode of a fuel cell which may be manufactured by conventional methods.

The present invention also provides an electrochemical device that includes the proton conductor. The electrochemical device may be a fuel cell that includes a cathode, an anode, and an electrolyte membrane interposed between the cathode and the anode, in which at least one of the cathode, the anode, and the electrolyte membrane includes the proton conductor.

The fuel cell may be manufactured by conventional methods.

The present invention is described below more specifically with reference to the following examples. The following examples are for illustrative purposes and are not intended to limit the scope of the invention.

### EXAMPLE 1

10 g of metaphosphoric acid ((HPO₃)₆) and 4 g of boric acid (H₃BO₃) were dissolved in 100 g of water. A TEFLON beaker was used because metaphosphoric acid is known to react with a PYREX glass vessel at high temperatures. A clear solution was obtained by completely dissolving the metaphosphoric acid and the boric acid in the water. The clear solution was thermally treated in a convection oven at 120° C. for 24 hours.

A clear amorphous sample was obtained as a result of the thermal treatment. The sample was cooled to room temperature and pulverized in a mortar. 0.3 g of the powder thus obtained was placed in a pellet jig. A pressure of 3,000 psia was applied to the jig for one minute to obtain pellets which were 1.3 cm in diameter and 1 mm thick. The pellets were inserted into a SUS electrode with a diameter of 1.5 cm and compressed to measure proton conductivity. The proton conductivity was 0.035 S/cm at 120° C.

### EXAMPLE 2

A proton conductor was manufactured in the same manner as in Example 1 except that the thermal treatment temperature was at 150° C. The proton conductivity of the proton conductor was measured under the same conditions as in Example 1. The proton conductivity of the proton conductor was 0.022 S/cm at 120° C.

### COMPARATIVE EXAMPLE

10 g of an 85% liquid phosphoric acid (H₃PO₄) and 4 g of boric acid (H₃BO₃) were dissolved in 100 g of water. A TEFLON beaker was used because liquid phosphoric acid is known to react with a PYREX glass vessel at high temperatures. A clear solution was obtained by completely dissolving the phosphoric acid and the boric acid in the water. The clear solution was thermally treated in a convection oven at 120° C. for 24 hours.

The sample obtained after the thermal treatment was cooled to room temperature and pulverized in a mortar. 0.3 g of the powder thus obtained was placed in a pellet jig. A is pressure of 3,000 psia was applied to the jig for one minute to obtain pellets which were 1.3 cm in diameter and 1 mm thick. The pellets were inserted in the middle of a SUS electrode with a diameter of 1.5 cm and compressed to measure proton conductivity. The proton conductivity was 0.00357 S/cm at 120° C.

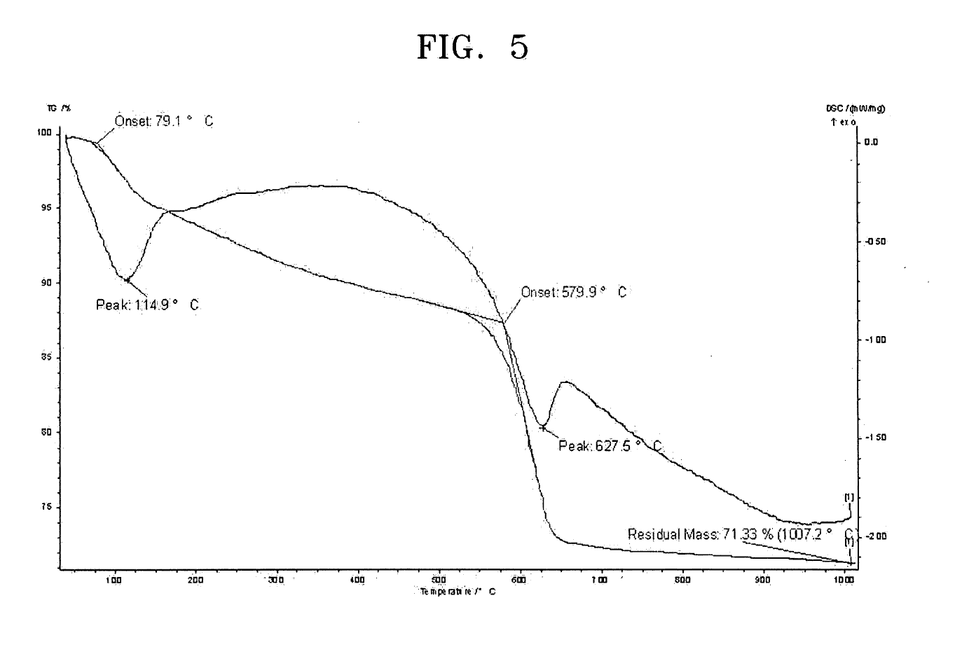

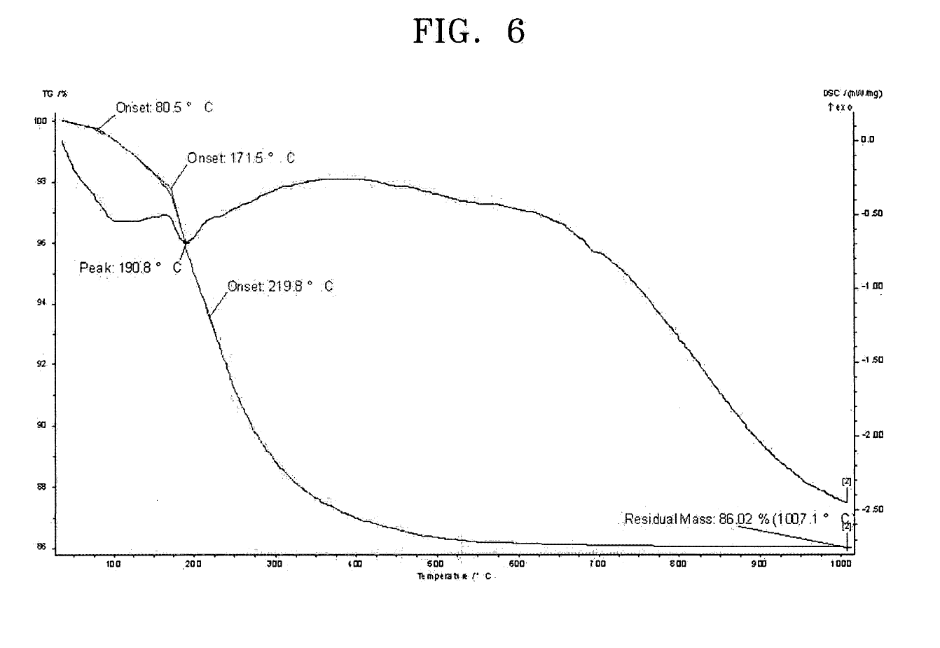

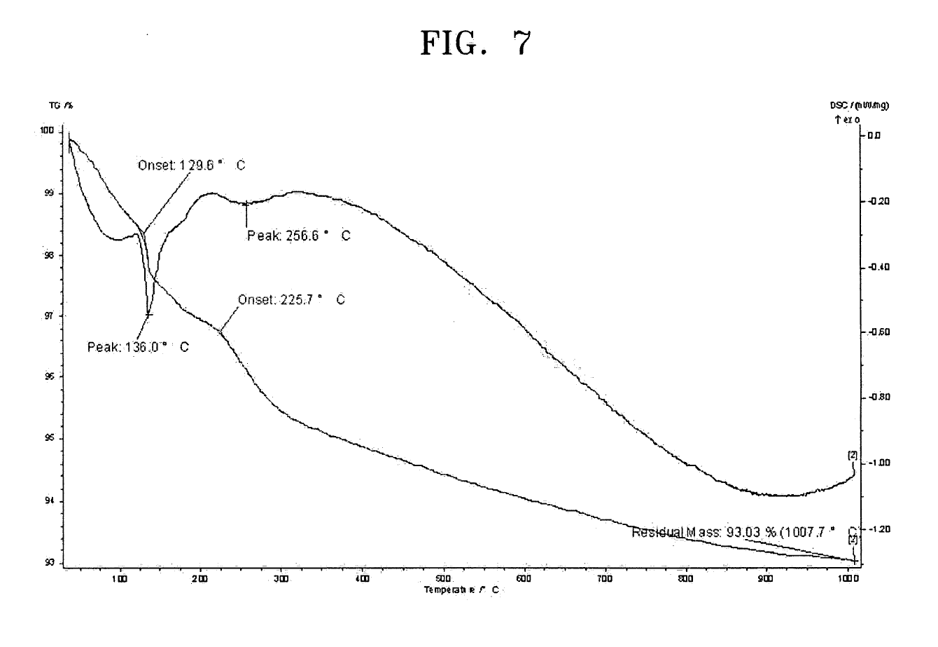

Thermal gravimetric analysis (TGA) was performed on the proton conductors manufactured in Example 1, Example 2, and the Comparative Example. The results are shown in the graphs of FIG. 5, FIG. 6, and FIG. 7, respectively. Residual mass values for the proton conductors of Example 1, Example 2, and the Comparative Example were obtained from the graphs of FIG. 5, FIG. 6, and FIG. 7, respectively. The residual mass values are presented in Table 1 below.

TABLE 1

| | Example 1 | Example 2 | Comparative Example |
|---|---|---|---|
| Residual mass | 71.33% | 73.21% | 93.03% |

Crystalline BPO₄ constitutes most of the residual mass. During the TGA analysis, amorphous B₂O₃ and P₂O₅, which play an important role in proton conduction in the present invention, are converted to crystalline BPO₄ at a temperature above 200° C. and evaporate at a temperature above 650° C. The residual mass at 1,000° C. consists of the mass of BPO₄ present upon production of a proton conductor and the mass of BPO₄ converted from B₂O₃ and P₂O₅.

As shown in Table 1, the residual mass of BPO₄ in the Comparative Example was remarkably higher than that in Example 1 and Example 2. This indicates that the ratio of the amorphous phase is much higher in Example 1 and Example 2 than that in the Comparative Example

X-ray diffraction (XRD) analysis was performed on the proton conductors manufactured in Example 1, Example 2, and the Comparative Example. The analysis results are shown in FIG. 4. Referring to FIG. 4, the proton conductor of the Comparative Example exhibited higher crystallinity than the proton conductors of Example 1 and Example 2. The proton conductor of Example 1, which was manufactured by thermal treatment at a lower temperature, exhibited lower crystallinity than the proton conductor of Example 2. The proton conductivity measurements show that as crystallinity increases, ionic conductivity decreases.

### EXAMPLE 3

10 g of metaphosphoric acid ((HPO₃)₆) and 4 g of boric acid (H₃BO₃) were dissolved in 100 g of water and 100 g of a Pt/C catalyst as a supported catalyst was added thereto. The reaction mixture was thermally treated in the same manner as in Example 1. 10 g of poly(vinyldifluoride) as a binder and 70 ml of N-methylpyrrolidone (NMP) were added to the resultant product and mixed to make a slurry. The slurry was coated on a surface of a water-proofed carbon cloth.

### EXAMPLE 4

10 g of metaphosphoric acid ((HPO₃)₆) and 4 g of boric acid (H₃BO₃) were dissolved in 100 g of water and 20 g of polyvinylidenefluoride (PVdF) as a polymer matrix was added thereto. The resultant mixture was placed in a mold and thermally treated in the same manner as in Example 1 to manufacture an electrolyte membrane.

### EXAMPLE 5

The electrode manufactured in Example 3 was attached to both surfaces of the electrolyte membrane manufactured in Example 4 according to a conventional method used to manufacture a unit cell. The performance test for the unit cell was performed at an operating temperature of 120° C. with hydrogen as fuel supplied at a rate of 100 ml/min and air as an oxidizing agent supplied at a rate of 200 ml/min. A voltage of 0.65 V was obtained at current density of 200 mA/cm².

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A proton conductor, comprising:
P₂O₅; and
at least one material selected from the group consisting of B₂O₃, ZrO₂, SiO₂, WO₃, and MoO₃.

2. The proton conductor of claim 1,
wherein the proton conductor has an amorphous phase of about 60 wt % or more.

3. The proton conductor of claim 1,
wherein a weight ratio of P₂O₅ to the at least one material is in the range from about 1:0.10 to about 1:1.33.

4. The proton conductor of claim 1,
wherein a weight ratio of P₂O₅ to B₂O₃ is in the range from about 1:0.12 to about 1:0.40.

5. The proton conductor of claim 1,
wherein a weight ratio of P₂O₅ to ZrO₂ is in the range from about 1:0.21 to about 1:0.71.

6. The proton conductor of claim 1,
wherein a weight ratio of P₂O₅ to SiO₂ is in the range from about 1:0.10 to about 1:0.35.

7. The proton conductor of claim 1,
wherein a weight ratio of P₂O₅ to WO₃ is in the range from about 1:0.40 to about 1:1.33.

8. The proton conductor of claim 1,
wherein a weight ratio of P₂O₅ to MoO₃ is in the range from about 1:0.25 to about 1:0.83.

9. A polymer electrolyte membrane, comprising:
the proton conductor of claim 1; and
a polymer matrix.

10. A fuel cell electrode, comprising:
the proton conductor of claim 1; and
a supported catalyst.

11. A fuel cell, comprising:
a cathode;
an anode; and
an electrolyte membrane interposed between the cathode and the anode,
wherein at least one of the cathode, the anode, and the electrolyte membrane comprises the proton conductor of claim 1.

12. A method of manufacturing a proton conductor, comprising:
mixing a solvent with solid acid and metaphosphoric acid to form a mixture; and
thermally treating the mixture.

13. The method of claim 12,
wherein a weight ratio of the metaphosphoric acid to the solid acid is in the range from about 1:0.01 to about 1:1.

14. The method of claim 13,
wherein a weight ratio of the metaphosphoric acid to the solid acid is in the range from about 1:0.2 to about 1:0.6.

15. The method of claim 12,
wherein the solvent comprises one or more selected from the group of water, methanol, ethanol, isopropyl alcohol, tetrabutylacetate, and n-butylacetate.

16. The method of claim 12,
wherein the thermal treatment is performed at a temperature in the range from about 100° C. to about 400° C.

17. A method of manufacturing a polymer electrolyte membrane, comprising:
mixing a solvent with a polymer matrix, a metaphosphoric acid, and a solid acid to form a mixture; and
thermally treating the mixture.

18. The method of claim 17,
wherein a weight ratio of the metaphosphoric acid to the solid acid is in the range from about 1:0.2 to about 1:0.6.

19. The method of claim 17,
wherein the solvent comprises one or more selected from the group of water, methanol, ethanol, isopropyl alcohol, tetrabutylacetate, and n-butylacetate.

20. The method of claim 17,
wherein the polymer matrix comprises one or more selected from the group of a perfluorinated polymer, a hydrocarbon polymer, polyimide, polyvinylidenefluoride, polybenzimidazole, polysulfone, polyethersulfone, polyetherketone, polyphenylenesulfide, polyphenyleneoxide, polyphosphazine, polyethylenenaphthalate, polyester, and polyamide.

21. The method of claim 17, wherein
a total amount of the metaphosphoric acid and the boric acid is in the range from about 50 to about 80 parts by weight based on 100 parts by weight of the metaphosphoric acid, the boric acid, and the polymer matrix.

22. The method of claim 17,
the thermal treatment is performed at a temperature in the range from about 100° C. to about 400° C.

23. A method of manufacturing a fuel cell electrode, comprising:
mixing a solvent with a supported catalyst, a metaphosphoric acid, and a solid acid to form a mixture; and
thermally treating the mixture.

24. The method of claim 23,
wherein a weight ratio of the metaphosphoric acid to the solid acid is in the range from about 1:0.2 to about 1:0.6.

25. The method of claim 23,
wherein the solvent comprises one or more selected from the group of water, methanol, ethanol, isopropyl alcohol, tetrabutylacetate, and n-butylacetate.

26. The method of claim 23,
wherein a total amount of the boric acid and the metaphosphoric acid is about 5 to about 25% by weight of the supported catalyst.

27. The method of claim 23,
wherein the thermal treatment is performed at a temperature in the range from about 100° C. to about 350° C.

28. The method of claim 12,
wherein the solid acid is the solid acid of boron, zirconium, silicon, tungsten or molybdenum.
